(19) United States
(12) Patent Application Publication
(10) Pub. No.: US 2026/0126159 A1
(43) Pub. Date: May 7, 2026

(54) LAMP FOR VEHICLE

(71) Applicant: SL Corporation, Daegu (KR)

(72) Inventors: Byung Dong CHOI, Gyeongsan-si (KR); Eun Chul JEONG, Gyeongsan-si (KR); Ji Ho HONG, Gyeongsan-si (KR); In Ho CHOI, Gyeongsan-si (KR); Jin Young JUNG, Gyeongsan-si (KR)

(21) Appl. No.: 19/365,041

(22) Filed: Oct. 21, 2025

(30) Foreign Application Priority Data
Nov. 7, 2024 (KR) 10-2024-0156692

(51) Int. Cl. F21S 41/24; F21S 41/255; F21W 102/155

(52) U.S. Cl. CPC F21S 41/24; F21S 41/255; F21W 2102/155

(57) ABSTRACT

A lamp for the vehicle includes at least one lamp module that forms a beam pattern. The at least one lamp module includes: at least one light source for emitting light in a forward direction; a light guide including at least one light-receiving portion and a light-emitting portion that are vertically spaced apart, wherein the light guide guides the light incident on the at least one light-receiving portion from the at least one light source to be emitted through the light-emitting portion in the forward direction; and an optical portion that allows the light emitted in the forward direction from the light guide to be transmitted therethrough and form the beam pattern.

### CROSS-REFERENCE TO RELATED APPLICATION

This application claims priority from Korean Patent Application No. 10-2024-0156692 filed on Nov. 7, 2024, which is incorporated herein by reference in its entirety.

### BACKGROUND

### 1. Technical Field

The present disclosure relates to a lamp for a vehicle, and more particularly, to a lamp for a vehicle capable of forming optimal beam patterns while reducing an installation space.

### 2. Description of Related Art

In general, a vehicle is provided with various types of lamps having an illumination function for more easily identifying an object located around the vehicle during low-light conditions (e.g., night driving) and a signaling function for notifying surrounding vehicles or a pedestrian of the driving state of the vehicle.

For example, a headlamp and a fog lamp are mainly used for the illumination functions, and a turn signal lamp, a tail lamp, and a brake lamp are mainly used for the signaling functions. Each lamp is stipulated by law in its installation standards and specifications so that each lamp may fully perform each function.

In such a lamp for a vehicle, an optical element such as a lens is disposed in a space positioned in a direction in which light is emitted from a light source, and a path or brightness of the light emitted from the light source is controlled by an optical element to satisfy required light distribution characteristics.

In this regard, when a plurality of light sources are used according to light distribution characteristics, light beams respectively emitted from the plurality of light sources are required to be sufficiently mixed with one another in order for the beam pattern to have a uniform brightness. To this end, it is necessary to radiate light beams respectively emitted from the plurality of light sources such that the light beams travel by a sufficient distance so that the light beams are mixed with one another in the lamp for a vehicle. However, to implement such a feature, a size of the lamp for a vehicle along the direction in which the light is emitted from the plurality of light sources increases, thereby increasing an installation space.

Therefore, there is a need for a scheme for reducing the installation space while allowing the beam pattern to have a uniform brightness.

### SUMMARY

A technical purpose to be achieved by the present disclosure is to provide a lamp for a vehicle that reduces a required installation space and improves uniformity of brightness of a beam pattern by adjusting a path of light emitted from a light source.

The technical purposes of the present disclosure are not limited to those mentioned above, and other technical purposes not mentioned may be clearly understood by those skilled in the art from descriptions as set forth below.

In order to achieve the above purpose, according to one aspect of the present disclosure, a lamp for a vehicle may include at least one lamp module that forms a beam pattern. Each of the at least one lamp module may include at least one light source for emitting light in a forward direction; a light guide including at least one light-receiving portion and a light-emitting portion that are vertically spaced apart, wherein the light guide guides the light incident on the at least one light-receiving portion from the at least one light source to be emitted through the light-emitting portion in the forward direction; and an optical portion that allows the light emitted in the forward direction from the light guide to be transmitted therethrough and form the beam pattern.

The light guide may allow the light that is incident onto the at least one light-receiving portion and proceeds in the forward direction to travel in a rearward direction at least one time and subsequently to be emitted in the forward direction through the light-emitting portion.

The light guide may further include a light-transfer portion that transmits the light between the at least one light-receiving portion and the light-emitting portion, and the light-transfer portion may include a plurality of reflective portions that reflect the light incident on the at least one light-receiving portion to allow the reflected light to proceed to the light-emitting portion.

At least one of the plurality of reflective portions may include a plurality of reflective areas. At least one of a formation angle or a curvature of one of the plurality of reflective areas may be different from at least another of the plurality of reflective areas.

A reflective portion among the plurality of reflective portions, which is disposed immediately upstream of the light-emitting portion along a light transfer path within the light-transfer portion, may consist essentially of a single reflective area.

The plurality of reflective portions may include a first reflective portion disposed in front of the at least one light-receiving portion; a second reflective portion arranged vertically with the first reflective portion and disposed more proximate to the light-emitting portion than the first reflective portion; a third reflective portion disposed longitudinally behind the second reflective portion; and a fourth reflective portion arranged vertically with the third reflective portion and disposed more proximate to the light-emitting portion than the third reflective portion.

The first reflective portion may reflect the light so as to cause it to travel vertically and toward the second reflective portion, the second reflective portion may reflect the light reflected from the first reflective portion so as to cause it to travel in a rearward direction and toward the third reflective portion, the third reflective portion may reflect the light reflected from the second reflective portion so as to cause it to travel vertically and toward the fourth reflective portion, and the fourth reflective portion may reflect the light reflected from the third reflective portion so as to cause it to travel in the forward direction and toward the light-emitting portion.

At least one of the first to third reflective portions may include a plurality of reflective areas. The fourth reflective portion may consist essentially of a single reflective area.

One end of both vertically opposing ends of the light-emitting portion that is closer to an optical axis of the optical portion may be disposed at or near a rear focus of the optical portion.

The light-emitting portion may exhibit a concave shape in which the light-emitting portion becomes closer to the optical portion as the light-emitting portion laterally extends from a center thereof toward each of both opposing sides thereof.

The optical portion may include a light-receiving surface on which the light emitted from the light guide is incident, and a light-emitting surface through which the light incident on the light-receiving surface is emitted. The light-receiving surface may be formed to be convex in a rearward direction, and the light-emitting surface may be formed to be convex in the forward direction. A curvature of the light-emitting surface may be formed to be greater than a curvature of the light-receiving surface.

In order to achieve the above purpose, according to another aspect of the present disclosure, a lamp for a vehicle may include a first lamp module and a second lamp modules that form a first beam pattern and a second beam pattern, respectively. The first lamp module may include at least one first light source for emitting light in a forward direction; a first light guide including at least one first light-receiving portion and a first light-emitting portion that are vertically spaced apart from each other, wherein the first light guide may guide the light incident on the at least one first light-receiving portion from the at least one first light source to be emitted through the first light-emitting portion in the forward direction; and an optical portion that allows the light emitted in the forward direction from the first light guide to be transmitted therethrough and form the first beam pattern. The second lamp module may be vertically arranged with the first lamp module with an optical axis of the optical portion being disposed therebetween in a vertical direction, and the second lamp module may include at least one second light source for emitting light in the forward direction; and a second light guide that guides the light incident thereon from the at least one second light source to travel to the optical portion and form the second beam pattern.

The first light guide may include a first light-transfer portion that transmits the light incident to the first light-receiving portion to the first light-emitting portion, and the first light-transfer portion may include a plurality of reflective portions arranged along a traveling path of the light incident to the first light-receiving portion.

The first light-transfer portion may allow the light that is incident to the first light-receiving portion and proceeds in the forward direction to be reflected from the plurality of reflective portions so as to travel in a rearward direction at least once and subsequently to be emitted in the forward direction through the first light-emitting portion.

A vertical spacing between the first light-emitting portion and the optical axis of the optical portion may be smaller than a vertical spacing between the first light-receiving portion and the optical axis of the optical portion.

A vertical spacing between the at least one first light source and the optical axis of the light source portion may be greater than a vertical spacing between the at least one second light source and the optical axis of the light source portion.

The second light guide may include at least one guiding member, each having a front end and a rear end, wherein the guiding member may guide light incident on the rear end from the at least one second light source to be emitted through the front end and subsequently to proceed to the optical portion. A vertical height of the front end of each of the at least one guiding member may be smaller than a vertical height of the first light-emitting portion.

The at least one guiding member may include a light path adjustment portion, and, with the second lamp module being turned off, the light path adjustment portion may reflect a portion of light transmitted from the first light guide so as to cause it to travel in the forward direction, thereby allowing a third beam pattern to be formed.

Other features of the present disclosure are included in the detailed description and drawings.

According to the lamp for the vehicle of the present disclosure as described above, one or more of the following effects may be provided.

The light emitted in the frontward direction from the light source may travel backwards at least once and then is emitted in the frontward direction. Thus, the overall size of the lamp can be reduced, allowing a required installation space to be reduced. Further, a sufficient travel distance of the light for the mixture of the light beams may be secured, such that uniformity of the brightness of the beam pattern may be improved.

The effects of the present disclosure are not limited to those mentioned above, and other effects not mentioned will be clearly understood by those skilled in the art from the description of the claims.

### BRIEF DESCRIPTION OF THE DRAWINGS

The above and other aspects and features of the present disclosure will become more apparent by describing in detail illustrative embodiments thereof with reference to the attached drawings, in which:

FIGS. 1 to 3 are perspective views showing a lamp for a vehicle according to an embodiment of the present disclosure;

FIG. 4 is a plan view illustrating a lamp for a vehicle according to an embodiment of the present disclosure;

FIG. 5 is a cross-sectional view taken along a line A-A′ of FIG. 4;

FIG. 6 is a schematic diagram illustrating a beam pattern formed by a lamp for a vehicle according to an embodiment of the present disclosure;

FIG. 7 is a schematic diagram illustrating a light path reflected by a plurality of reflective areas of a first reflective portion according to an embodiment of the present disclosure.

FIG. 8 is a schematic diagram illustrating a light path of a lamp for a vehicle according to an embodiment of the present disclosure;

FIGS. 9 to 12 are perspective views showing a lamp for a vehicle according to another embodiment of the present disclosure;

FIG. 13 is a bottom view illustrating a lamp for a vehicle according to another embodiment of the present disclosure;

FIG. 14 is a cross-sectional view taken along a line B-B′ of FIG. 13;

FIG. 15 is a schematic diagram illustrating a beam pattern formed by a second lamp module according to another embodiment of the present disclosure;

FIG. 16 is a schematic diagram illustrating a light path of a lamp for a vehicle according to another embodiment of the present disclosure;

FIG. 17 is a perspective view illustrating a lamp for a vehicle according to still another embodiment of the present disclosure;

FIG. 18 is a cross-sectional view illustrating a lamp for a vehicle according to still another embodiment of the present disclosure; and

FIG. 19 is a schematic diagram illustrating a beam pattern formed by a lamp for a vehicle according to still another embodiment of the present disclosure.

### DETAILED DESCRIPTION

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Throughout the specification, like reference numerals in the drawings denote like elements.

In some embodiments, well-known steps, structures and techniques will not be described in detail to avoid obscuring the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the disclosure are described herein with reference to plan and cross-section illustrations that are schematic illustrations of idealized embodiments of the invention. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. In the drawings, respective components may be enlarged or reduced in size for convenience of explanation.

Hereinafter, the present disclosure will be described with reference to drawings for illustrating a lamp for a vehicle according to embodiments of the present disclosure.

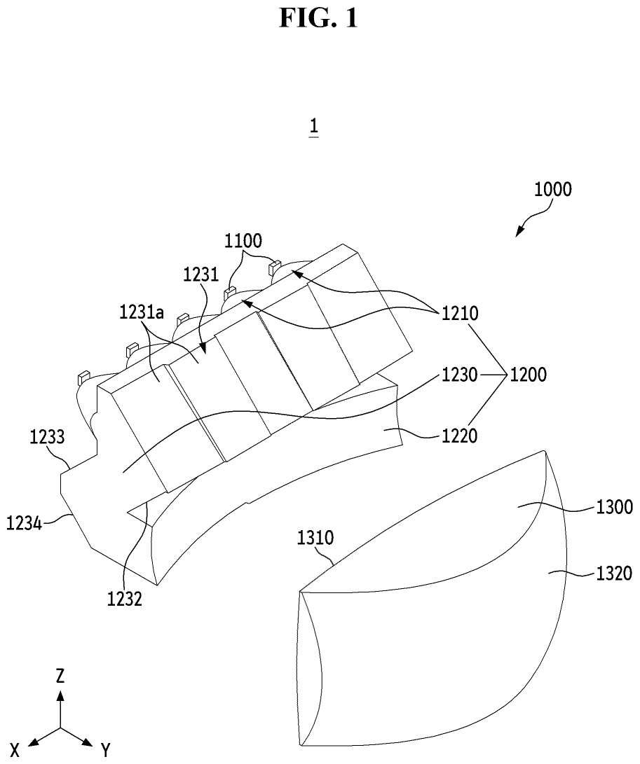

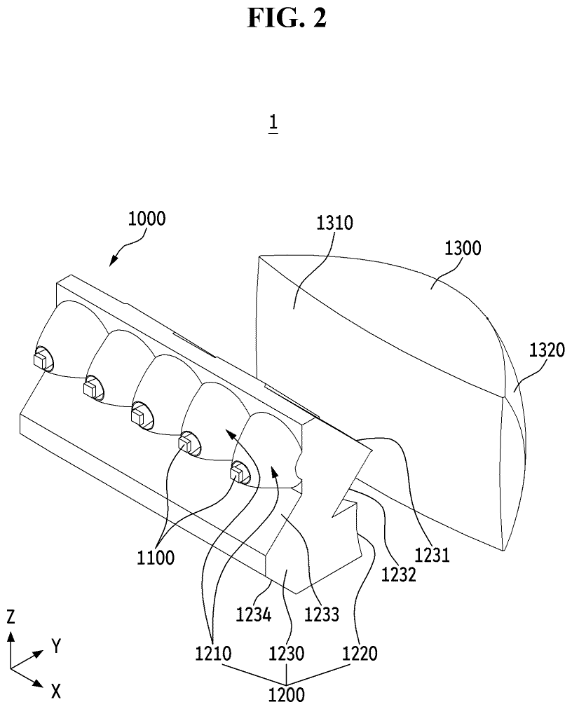

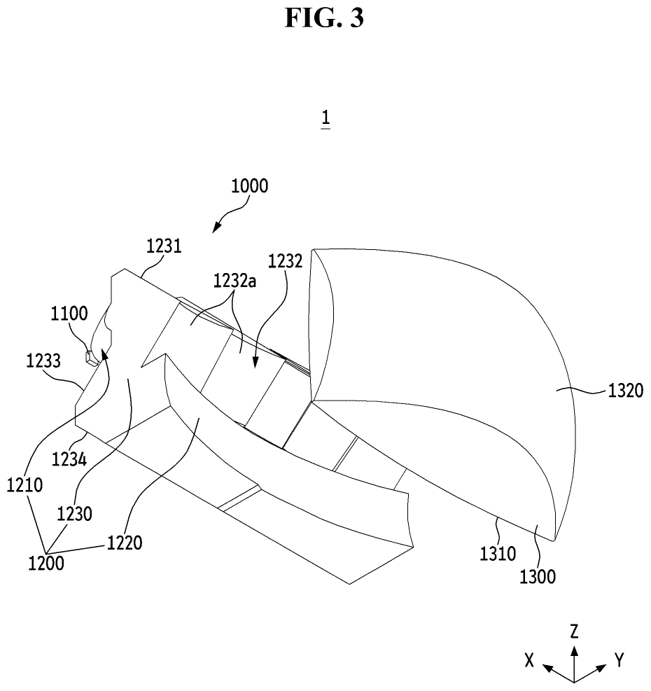

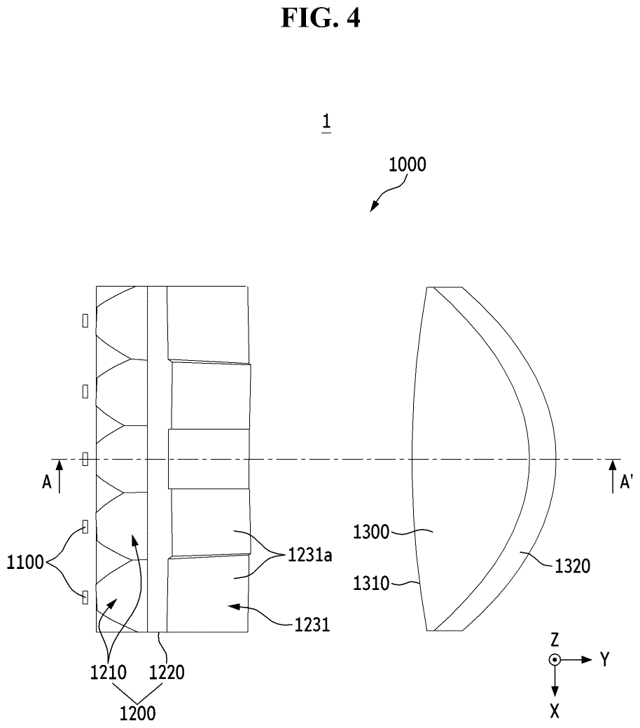

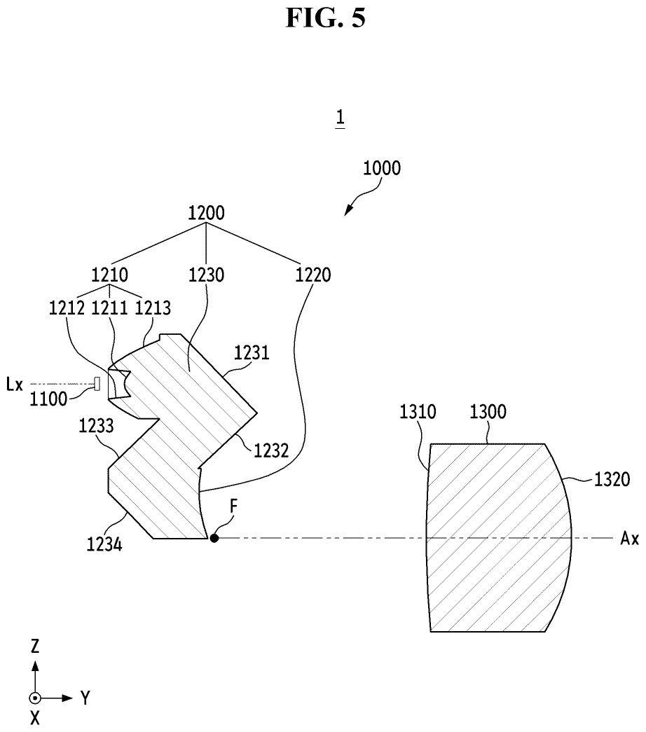

FIGS. 1 to 3 are perspective views showing a lamp for a vehicle according to an embodiment of the present disclosure, FIG. 4 is a plan view showing the lamp for a vehicle according to an embodiment of the present disclosure, and FIG. 5 is a cross-sectional view taken along a line A-A′ of FIG. 4.

Referring to FIGS. 1 to 5, a lamp 1 for a vehicle according to an embodiment of the present disclosure may include at least one lamp module 1000.

In an embodiment of the present disclosure, a case in which the lamp 1 for a vehicle is used as a head lamp for securing a front view of a vehicle by irradiating light in a proceeding direction of the vehicle when the vehicle is operated at night or in a dark place such as a tunnel will be described. However, the present disclosure is not limited thereto, and the lamp 1 for a vehicle of the present disclosure may be used not only for a head lamp but also for various lamps installed in the vehicle, such as a tail lamp, a brake lamp, a daytime running lamp, a turn signal lamp, a fog lamp, a backup lamp, a position lamp, and the like. The lamp 1 for a vehicle of the present disclosure may be used for any one of the above-described purposes or may be used for two or more purposes.

In addition, in an embodiment of the present disclosure, a case in which an X-axis direction means a vehicle width direction as a left-right direction (e.g., a lateral direction), a Y-axis direction means a front-rear direction (in a frontward direction or backward) as a driving direction (e.g., a longitudinal direction), and a Z-axis direction means a vehicle height direction as a vertical direction will be described by way of example. However, the present disclosure is not limited thereto, and the directions which the X-axis, the Y-axis, and the Z-axis actually mean may vary according to the position and/or the direction in which the lamp 1 for a vehicle of the present disclosure is installed.

When the lamp 1 for a vehicle of the present disclosure is used as a head lamp, the lamp 1 for a vehicle may form at least one of a low beam pattern or a high beam pattern. The low beam pattern may be for securing a wider field of view of a short distance in front of the vehicle by irradiating light to an area under the cut-off line so that glare does not occur to a driver of a vehicle in front of the present vehicle, such as a preceding vehicle or an on-coming vehicle. The high beam pattern may be for securing a longer field of view of a long distance in front of the vehicle. When the high beam pattern is formed, the low beam pattern may be formed together therewith to secure a wider and longer field of view in front of the vehicle.

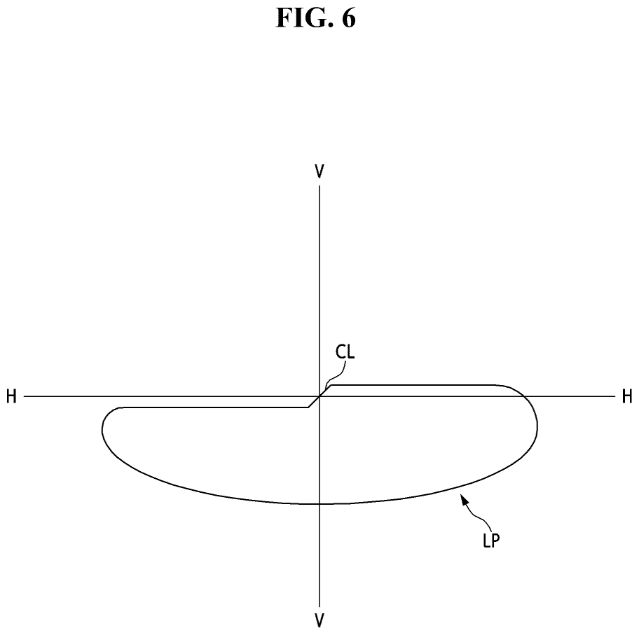

Hereinafter, in an embodiment of the present disclosure, a case in which the lamp 1 for a vehicle of the present disclosure forms the low beam pattern LP in which light is irradiated below the cut-off line CL as shown in FIG. 6 will be described by way of example. A case in which the low beam pattern LP of FIG. 6 is a beam pattern formed by light irradiated on a screen disposed at a set distance in front of the vehicle from the lamp 1 for a vehicle of the present disclosure will be described by way of example.

In an embodiment of the present disclosure, a case in which at least one lamp module 1000 includes a single lamp module 1000 will be described by way of example. However, the present disclosure is not limited thereto, and the number and arrangement direction of the lamp modules may be variously changed according to the light distribution characteristics of the beam pattern to be formed by the lamp 1 for a vehicle of the present disclosure, that is, a position, size, shape, brightness, and the like of an area to which light is irradiated.

Each of the at least one lamp module 1000 may include at least one light source 1100, a light guide 1200, and an optical portion 1300.

The at least one light source 1100 may emit light having a light amount and/or color suitable for a beam pattern to be formed by the lamp 1 for a vehicle according to the present disclosure. An embodiment of the present disclosure will be described based on an example in which the at least one light source 1100 includes a plurality of light sources 1100 arranged in the left-right direction. However, the present disclosure is not limited thereto, and the number and arrangement direction of the light sources may be variously changed according to the light distribution characteristics of the beam pattern to be formed by the lamp 1 for a vehicle according to the present disclosure.

The at least one light source 1100 may have an optical axis Lx parallel to a front-rear direction and may emit light in a frontward direction. In an embodiment of the present disclosure, the at least one light source 1100 that emits the light in the frontward direction is one example under an assumption that the direction of the light to be emitted from the vehicle lamp 1 of the present disclosure is the frontward direction. The direction actually referred to by the frontward direction may vary depending on the position at which the vehicle lamp 1 of the present disclosure is installed.

In this regard, the optical axis Lx of the at least one light source 1100 may be understood as an axis that passes through the center of the light emitting surface or area in a perpendicular manner thereto.

In an embodiment of the present disclosure, a case in which a semiconductor light emitting element such as a light emitting diode (LED) is used as the at least one light source 1100 will be described by way of example. However, the present disclosure is not limited thereto, and the at least one light source 1100 may be embodied as various types of light sources such as a Laser Diode (LD) or a bulb as well as a LED.

The light guide 1200 may serve to adjust a path of light to allow the light emitted from the at least one light source 1100 in a frontward direction to travel backward at least once and then is emitted in the frontward direction.

The light guide 1200 may include at least one light-receiving portion 1210, a light-emitting portion 1220, and a light-transfer portion 1230. The at least one light-receiving portion 1210 may be disposed in front of the at least one light source 1100 and may receive the light emitted in a frontward direction from the at least one light source 1100, and may serve to concentrate the light emitted from the at least one light source 1100 and incident thereon. In an embodiment of the present disclosure, a case in which the at least one light-receiving portion 1210 includes a plurality of light-receiving portions 1210 arranged in the left-right direction will be described by way of example. This configuration is because the at least one light source 1100 includes a plurality of light sources 1100 arranged in the left-right direction, and the number of the light-receiving portions 1210 corresponds to the number of the light sources 1110.

The at least one light-receiving portion 1210 may include a central surface 1211 that is intersected by the optical axis Lx of the at least one light source 1100 at a center point thereto, a protruding surface 1212 that protrudes from an edge of the central surface 1211 toward the at least one light source 1100, and a reflective surface 1213 that reflects light incident on the protruding surface 1212 therefrom so as to proceed in a frontward direction.

The light-emitting portion 1220 may allow the light incident on the at least one light-receiving portion 1210 to be emitted and incident on the optical portion 1300 disposed in front of the light guide 1200. The light-emitting portion 1220 may be formed to have a concave shape in which the light-emitting portion 1220 is closer to the optical portion 1300 along the focal plane of the optical portion 1300 as the light-emitting portion 1220 extends from the center toward each of both opposing sides in the left-right direction.

In this regard, one end closer to a central axis Ax of the optical portion 1300 among both opposing ends in the vertical direction of the light-emitting portion 1220 may be disposed at or near a rear focus F of the optical portion 1300. Thus, the cut-off line CL shown in FIG. 6 described above may be formed. The rear focus F of the optical portion 1300 may have a shape of a point, a line, a surface, a space, or any combinations thereof according to an area onto which the light is actually concentrated.

In an embodiment of the present disclosure, the case in which the low beam pattern LP is formed by the lamp 1 for a vehicle is described by way of example. Thus, it may be understood that the light guide 1200 is disposed above the central axis Ax of the optical portion 1300. In this regard, a lower end of the light light-emitting portion 1220 may be disposed at or near the rear focus F of the optical portion 1300.

In other words, since the light incident to the optical portion 1300 through a space under the rear focus F of the optical portion 1300 would be refracted and emitted in an upward direction, and would be irradiated to an area above the cut-off line CL, potentially causing glare, in an embodiment of the present disclosure, the lower end of the light-emitting portion 1220 may be disposed at or near the rear focus F of the optical portion 1300, such that the light may be prevented from proceeding through the space under the rear focus F of the optical portion 1300 to the optical portion 1300.

In addition, a surface that extends rearwards from the lower end of the light light-emitting portion 1220 may reflect the light that travels from a position behind the rear focus F of the optical portion 1300 to a position under the rear focus F such that the reflected light travels through the light light-emitting portion 1220, thereby allowing the light that is blocked for a purpose of preventing the glare to be reused, thereby improving light efficiency.

In one example, the at least one light-receiving portion 1210 may be disposed above the light-emitting portion 1220 and be spaced from the central axis Ax of the optical portion 1300 by an offset greater than an offset between the light-emitting portion 1220 and the central axis Ax. This configuration is to allow the light emitted in the frontward direction from the at least one light source 1100 to travel backwards at least once, thereby increasing a distance by which the light travels between the at least one light-receiving portion 1210 and the light light-emitting portion 1220. Thus, even when the vehicle lamp 1 of the present disclosure includes the plurality of light sources 1100, a path having a sufficient distance for mixing light beams respectively emitted from the plurality of light sources 1100 with one another may be secured, thereby improving uniformity of brightness of a beam pattern formed by the vehicle lamp 1 of the present disclosure.

In other words, if the light emitted in a frontward direction from each of the plurality of light sources 1100 directly proceeds in a forward direction to form the beam pattern, the distance required in the front-rear direction to sufficiently mix the light beams respectively emitted from the plurality of light sources 1100 increases, and thus the size in the front-rear direction (e.g., the longitudinal length) of the lamp for a vehicle increases. However, in an embodiment of the present disclosure, the path of the light is adjusted so that the light emitted in a frontward direction from each of the plurality of light sources 1100 travels backwards at least once and then is emitted in the frontward direction through the light-emitting portion 1220. Thus, the size in the front-rear direction of the lamp 1 for a vehicle according to the present disclosure may be reduced, and a distance in the front-rear direction for sufficiently mixing the light beams respectively emitted from the plurality of light sources 1100 with one another may be secured.

The light-transfer portion 1230 may include a plurality of reflective portions (e.g., surfaces) 1231, 1232, 1233, and 1234 configured to allow the light incident on at least one light-receiving portion 1210 to be reflected therefrom so as to be transmitted to the light-emitting portion 1220. In an embodiment of the present disclosure, each of the plurality of reflective portions 1231, 1232, 1233, and 1234 will be referred to as a first reflective portion 1231, a second reflective portion 1232, a third reflective portion 1233, and a fourth reflective portion 1234.

The first reflective portion 1231 may be disposed in front of the at least one light-receiving portion 1210 and may reflect the light incident on the at least one light-receiving portion 1210 and proceeding in a frontward direction therefrom so as to cause it to travel downwardly toward the light-emitting portion 1220 disposed closer to the central axis Ax of the optical portion 1300 than the at least one light-receiving portion 1210.

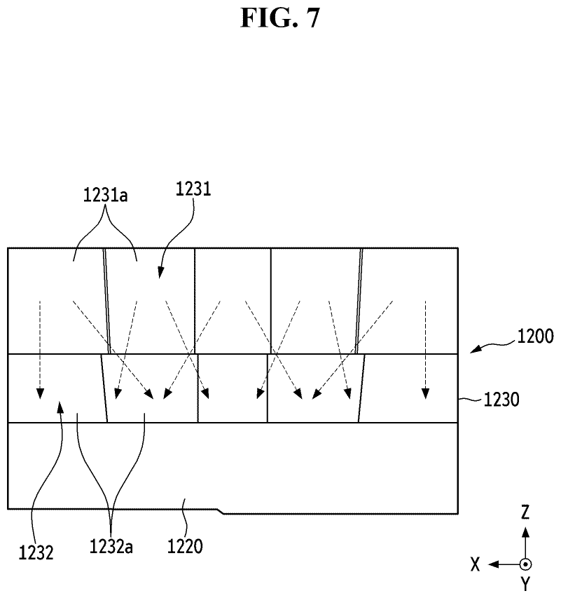

In this regard, the first reflective portion 1231 may include a plurality of reflective areas 1231a. As shown in the broken line arrows in FIG. 7, one of the plurality of reflective areas 1231a may be formed to have a different angle or curvature from that of another and may thus have different reflective characteristics from another. Thus, even when the at least one light source 1100 includes the plurality of light sources 1100, the light beams respectively emitted from the plurality of light sources 1100 may be mixed with one another.

In an embodiment of the present disclosure, a case in which the number of the plurality of reflective areas 1231a corresponds to the number of the light sources 1100 will be described by way of example. However, the present disclosure is not limited thereto, and the number of the plurality of reflective areas 1231a may be different from that of the light sources 1100.

The second reflective portion 1232 may serve to reflect the light reflected downwardly by the first reflective portion 1231 therefrom so as to cause it to travel rearward. In an embodiment of the present disclosure, a case in which the second reflective portion 1232 also includes a plurality of reflective areas 1232a for the reason similar to that provided above regarding the first reflective portion 1231 will be described by way of example.

The third reflective portion 1233 may be disposed in rear of the second reflective portion 1232 and may reflect the light reflected from the second reflective portion 1232 so as to cause it to travel downwardly toward the light-emitting portion 1220 disposed closer to the central axis Ax of the optical portion 1300 than the at least one light-receiving portion 1210.

The fourth reflective portion 1234 may serve to reflect the light reflected from the third reflective portion 1233 so as to cause the light to travel in a frontward direction, and then be emitted through the light-emitting portion 1220.

In an embodiment of the present disclosure, a case in which each of the third reflective portion 1233 and the fourth reflective portion 1234 includes a single reflective area is described by way of example. This configuration is to allow the light emitted through the light-emitting portion 1220 to have a more uniform brightness. More specifically, if the reflective portion, that is, the fourth reflective portion 1234, disposed in rear of the light-emitting portion 1220 along the path of the light includes a plurality of reflective areas, the plurality of reflective areas may exhibit different reflective characteristics, and thus the uniformity of brightness may be deteriorated.

To this end, in an embodiment of the present disclosure, at least one of the first reflective portion 1231 to the third reflective portion 1233 may include the plurality of reflective areas, and the fourth reflective portion 1234 may include a single reflective area.

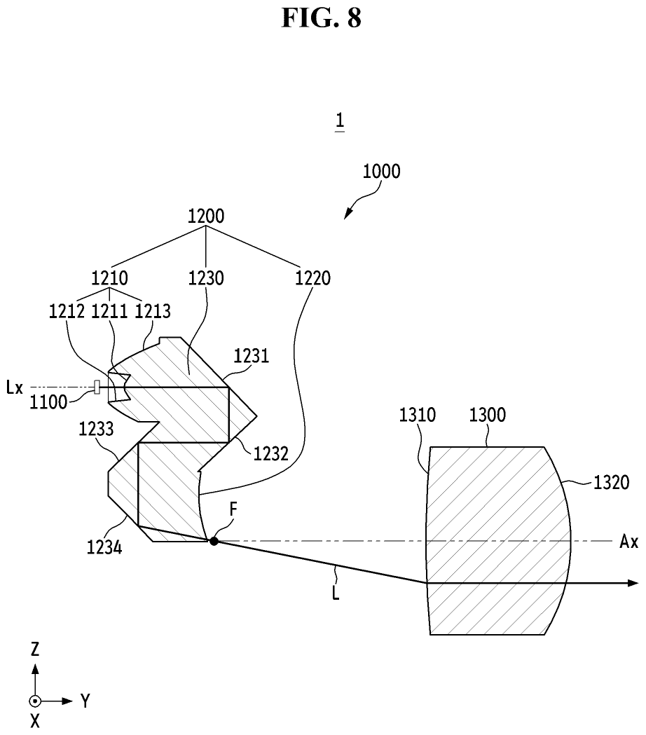

FIG. 8 is a schematic diagram showing a light path of a lamp for a vehicle according to an embodiment of the present disclosure. Referring to FIG. 8, the path of the light may be adjusted such that the light L incident to the at least one light-receiving portion 1210 and traveling in a frontward direction may be reflected by the first reflective portion 1231 and then by the second reflective portion 1232 so as to travel backwards. Further, the path of the light may be adjusted such that the light may be reflected by the third reflective portion 1233 and then by the fourth reflective portion 1234 so as to travel in a frontward direction. Thus, even when the light beams are respectively emitted from the plurality of light sources 1100, a sufficient distance for mixing the light beams respectively emitted from the plurality of light sources 1100 from one another may be secured, and thus the overall length of the lamp 1 for a vehicle according to the present disclosure can be reduced, and at the same time, the uniformity of brightness can be improved.

In the above-described embodiment, a case in which the path of the light is adjusted so that the light incident on the at least one light-receiving portion 1210 and traveling in a frontward direction travels backwards once and then travels in a frontward direction is described by way of example. However, the present disclosure is not limited thereto. Grouping the first to fourth reflective portions 1231, 1232, 1233, and 1234 as one group, two or more such groups may be arranged along the path of the light to achieve the light travel distance as required for sufficient mixing of the light beams in the lamp 1 for a vehicle according to the present disclosure.

The optical portion 1300 may include a light-receiving surface 1310 and a light-emitting surface 1320 and may allow the light incident to the light-receiving surface 1310 from the light guide 1200 to be emitted through the light-emitting surface 1320, thereby forming a beam pattern suitable for the application of the lamp 1 for a vehicle of the present disclosure. In an embodiment of the present disclosure, the light-receiving surface 1310 may be formed to have a convex shape toward the rearward direction, and the light-emitting surface 1320 may be formed to have a convex shape toward the forward direction.

In this regard, the optical portion 1300 may be formed such that the light-emitting surface 1320 has a greater curvature than that of the light-receiving surface 1310, such that more effective light concentration is achieved by the light-emitting surface 1320.

In the above-described embodiment, a case in which a single beam pattern is formed by the lamp 1 for a vehicle of the present disclosure is described by way of example. However, the present disclosure is not limited thereto, and a plurality of different beam patterns may be formed by the lamp 1 for a vehicle of the present disclosure.

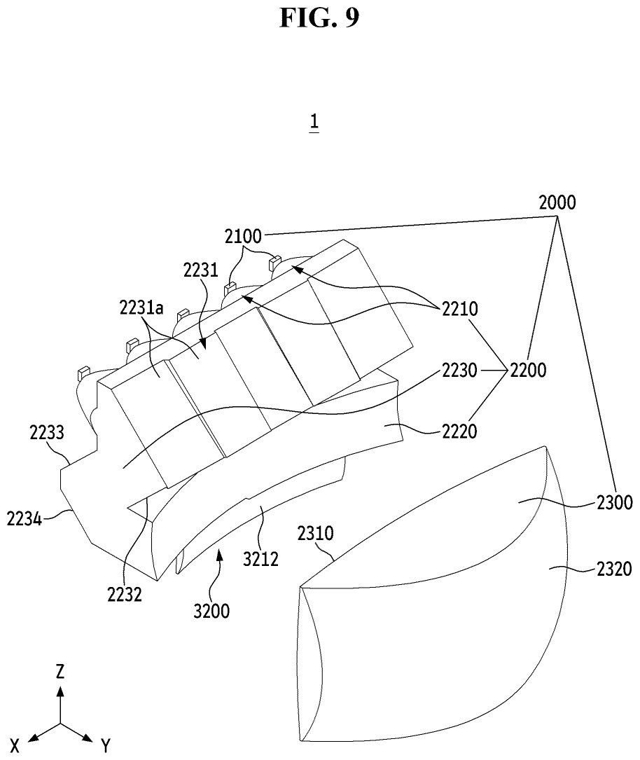

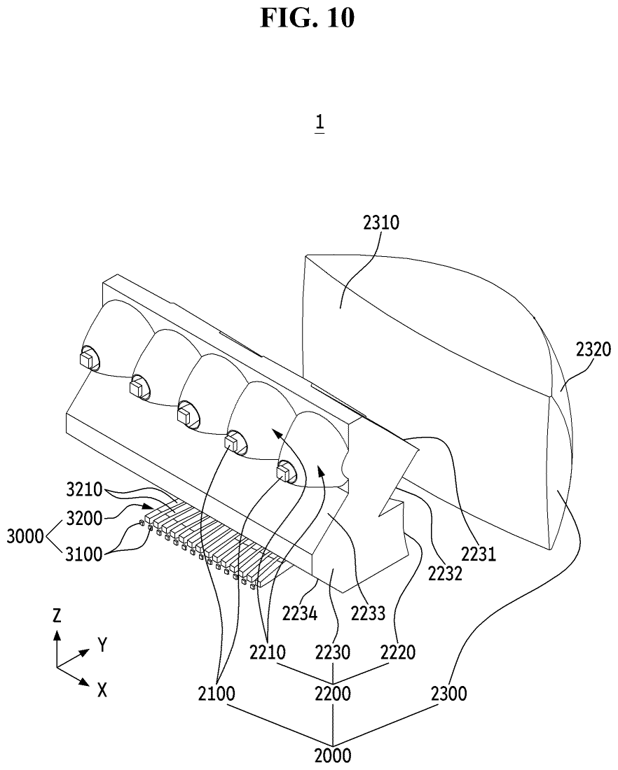

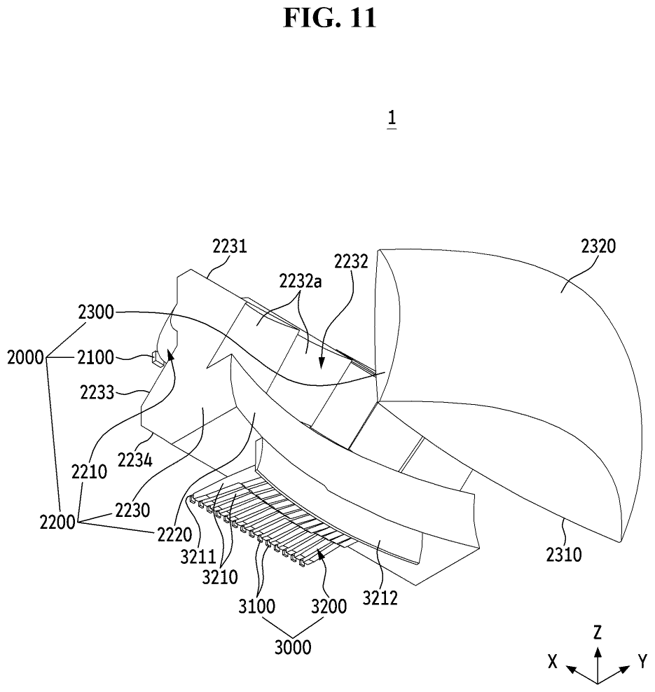

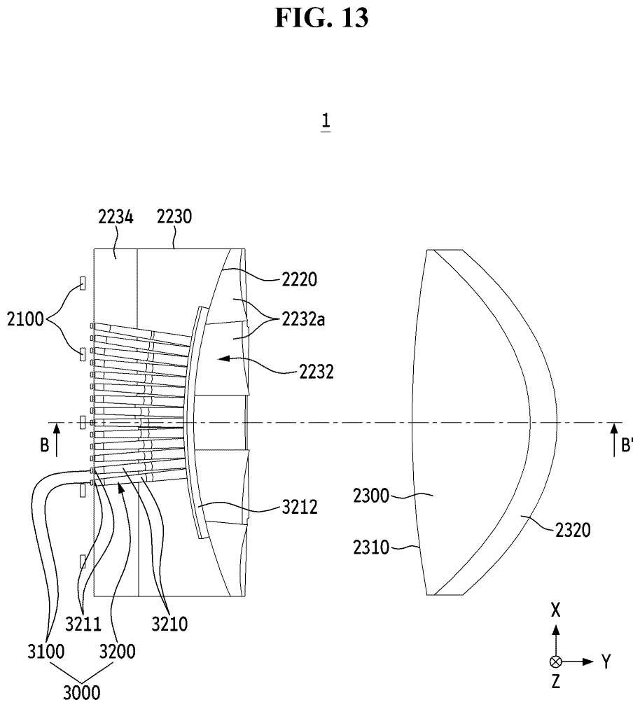

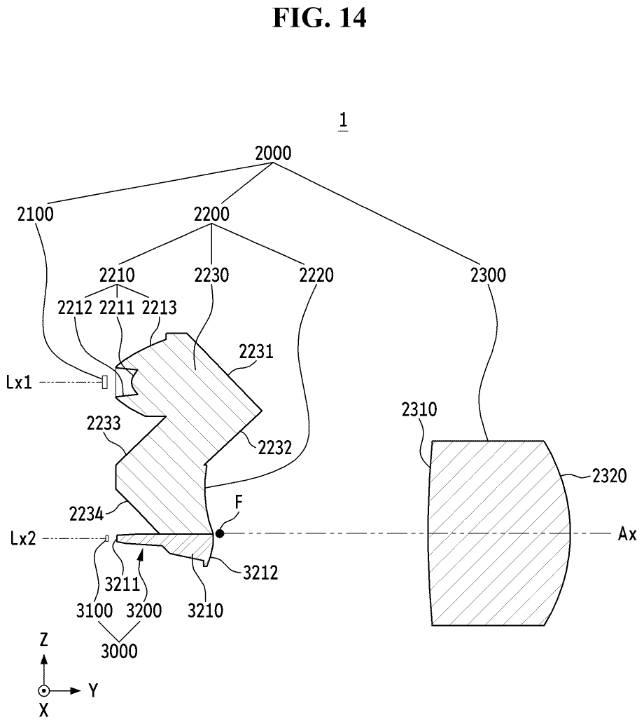

FIGS. 9 to 12 are perspective views showing a lamp for a vehicle according to another embodiment of the present disclosure, FIG. 13 is a bottom view showing a lamp for a vehicle according to another embodiment of the present disclosure, and FIG. 14 is a cross-sectional view taken along a line B-B′ of FIG. 13.

Referring to FIGS. 9 to 14, a lamp 1 for a vehicle according to another embodiment of the present disclosure may include a first lamp module 2000 for forming a first beam pattern and a second lamp module 3000 for forming a second beam pattern.

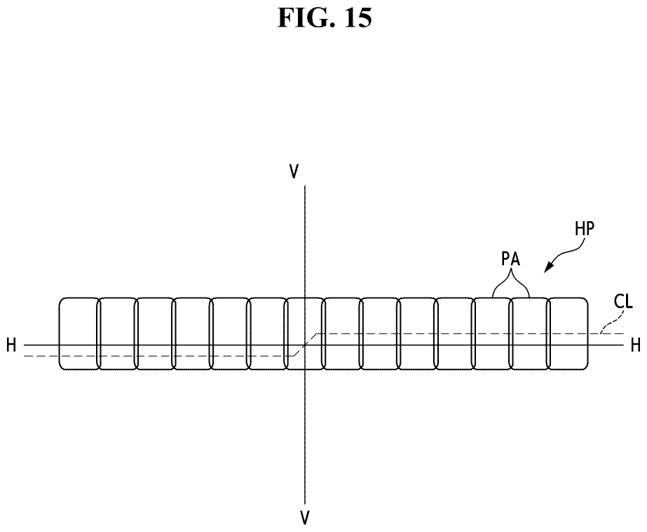

In the another embodiment of the present disclosure, a case in which the first beam pattern is the low beam pattern LP shown in FIG. 6 described above, and the second beam pattern is the high beam pattern HP, which is at least partially irradiated to an area above the cut-off line CL as shown in FIG. 15, will be described by way of example. Thus, when the high beam pattern HP is formed, the low beam pattern LP may be formed together therewith to secure a longer viewing distance and a wider viewing range in front of the vehicle.

In this regard, the high beam pattern HP may include a plurality of pattern areas PA arranged in the left-right direction. To prevent causing glare toward the driver of the front vehicle, at least one of the plurality of pattern areas PA may be removed or brightness thereof may be reduced according to a position of a vehicle in front of the vehicle equipped with the lamp 1.

The case that the first beam pattern is the low beam pattern LP and the second beam pattern is the high beam pattern HP is merely an example for helping understanding of the present disclosure. The present disclosure is not limited thereto, and the first beam pattern and the second beam pattern may be understood as beam patterns having different light distribution characteristics.

The first lamp module 2000 and the second lamp module 3000 may be respectively disposed at opposite sides with respect to a central axis Ax of the optical portion 2300 to be described later. In an embodiment of the present disclosure, an example in which the first lamp module 2000 is disposed above the central axis Ax of the optical portion 2300 and the second lamp module 3000 is disposed below the central axis Ax of the optical portion 2300 will be described by way of example. Accordingly, the low beam pattern LP may be formed by the first lamp module 2000, and the high beam pattern HP may be formed by the second lamp module 3000.

In this embodiment of the present disclosure, the first lamp module 2000 may include at least one first light source 2100, a first light guide 2200, and an optical portion 2300, and each of the at least one first light source 2100, the first light guide 2200, and the optical portion 2300 may function similarly as each of the at least one light source 1100, the light guide 1200, and the optical portion 1300 of the above-described embodiment, and a detailed description thereof will be omitted.

The at least one first light source 2100 may have an optical axis Lx1 parallel to the front-rear direction, and may emit light having a light amount and/or color suitable for the first beam pattern in the frontward direction.

The first light guide 2200 may include at least one first light-receiving portion 2210, a first light-emitting portion 2220, and a first light-transfer portion 2230.

The at least one first light-receiving portion 2210 may include a central surface 2211 that intersects with the optical axis Lx1 of the at least one first light source 2100 at a center point thereof, a protruding surface 2212 formed to protrude from an edge of the central surface 2211 toward the at least one first light source 2100, and a reflective surface 2213 that reflects the light incident on the protruding surface 2212 so as to cause it to travel in a frontward direction.

A lower end of the first light-emitting portion 2220 may be disposed at or near the rear focus F of the optical portion 2300 to form the cut-off line CL of the low beam pattern LP as described above with reference to FIG. 6.

The first light-transfer portion 2230 may include first to fourth reflective portions 2231, 2232, 2233, and 2234. The first reflective portion 2231 may include a plurality of reflective areas 2231a. The second reflective portion 2232 may also include a plurality of reflective areas 2232a. Each of the third reflective portion 2233 and the fourth reflective portion 2234 may include a single reflective area.

The first light-transfer portion 2230 may allow the light incident on the at least one first light-receiving portion 2210 and traveling in a frontward direction to be reflected from the first reflective portion 2231 and the second reflective portion 2232 so as to cause it to travel backwards. The light may then be reflected from the third reflective portion 2233 and the fourth reflective portion 2234 so as to travel in a frontward direction again. Thus, even though the at least one first light source 2100 includes the plurality of first light sources 2100, a distance for allowing the light beams respectively emitted from the plurality of first light sources 2100 to be sufficiently mixed with one another may be secured between the at least one first light-receiving portion 2210 and the first light-emitting portion 2220.

In a similar manner to the above-described embodiment, the optical portion 2300 may be configured such that a light-receiving surface 2310 thereof is formed to be convex rearwards for condensing of the light, and a light-emitting surface 2320 thereof is formed to be convex in a frontward direction for condensing of the light. The light-emitting surface 2320 may be formed to have a greater curvature than that of the light-receiving surface 2310.

The second lamp module 3000 may include at least one second light source 3100 and a second light guide 3200.

The at least one second light source 3100 may have an optical axis Lx2 parallel to the front-rear direction in a similar manner to the at least one first light source 2100, and may emit light forward, having a light amount and/or color suitable for the second beam pattern. The second light guide 3200 may include at least one guiding member 3210 having a rear end 3211 and a front end 3212. The guiding member 3210 may allow the light incident on the rear end 3211 from the at least one second light source 3100 to be emitted through the front end 3212 and to travel toward the optical portion 2300. In this regard, the optical portion 2300 may be shared by the first lamp module 2000 and the second lamp module 300.

In this regard, the optical axis Lx1 of the at least one first light source 2100 and the optical axis Lx2 of the at least one second light source 3100 may be parallel to each other and are vertically spaced apart from each other while the central axis Ax of the optical portion 2300 is interposed therebetween. Thus, the at least one first light source 2100 and the at least one second light source 3100 may be installed on a common substrate, and thus, the number of components may be reduced compared to the case in which individual substrates are respectively required for the at least one first light source 2100 and the at least one second light source 3100. The use of common substrate can decrease a cost and improve heat dissipation performance.

In another embodiment of the present disclosure, a case in which the at least one second light source 3100 includes a plurality of second light sources 3100 arranged in the left-right direction and the at least one guiding member 3210 includes a plurality of guiding members 3210 corresponding to the plurality of second light sources 3100, respectively, will be described. Thus, as shown in FIG. 15 as described above, the high beam patterns HP may include a plurality of pattern areas PA arranged in the left-right direction, and at least one of the plurality of second light sources 3100 may be turned off depending on the position of the front vehicle so that at least one of the plurality of pattern areas PA is not formed and instead forms a shadow zone, thereby preventing glare toward the driver of the front vehicle.

In another embodiment of the present disclosure, the second light guide 3200 may include the plurality of guiding members 3210, and the front ends 3212 of the plurality of guiding members 3210 may be integrally formed with one another to form a single light-emitting surface, thereby enabling a simpler outer appearance as well as fixing the positions of of the plurality of guiding members 3210.

In this regard, the plurality of guiding members 3210 being integrally formed may include not only a case in which they are integrally manufactured, but also a case in which they are separately manufactured and coupled to one another so as not to move relative to one another.

In addition, the first light-emitting portion 2220 may have a greater length in the vertical direction (e.g., a height) than that of the front end 3212 of each of the plurality of guiding members 3210. This configuration is intended to form the low beam pattern LP so as to have a greater height than that of the high beam pattern HP, which may improve the viewing angle in the near field in front of the vehicle, and may form the high beam pattern HP to have a higher concentration than that of the low beam pattern LP to improve the viewing distance in the far field in front of the vehicle.

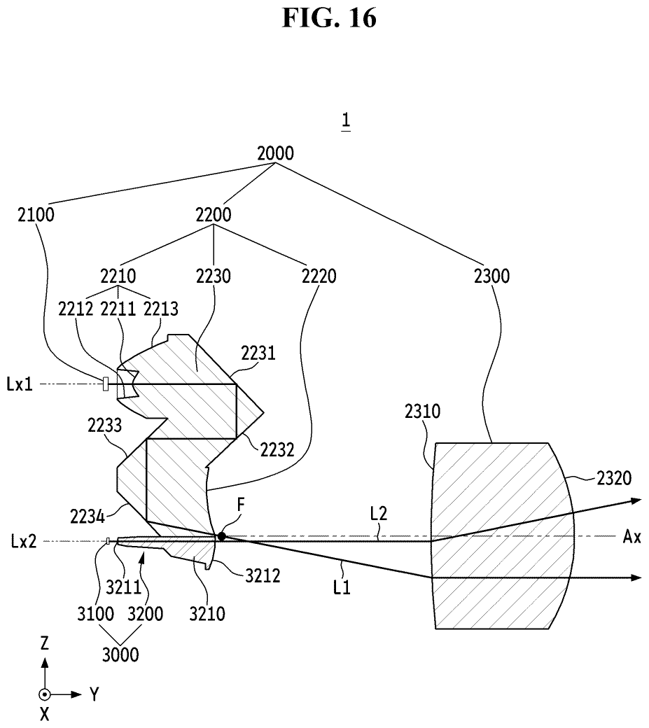

FIG. 16 is a schematic diagram illustrating a light path of a lamp for a vehicle according to another embodiment of the present disclosure. Referring to FIG. 16, in the lamp 1 for a vehicle according to another embodiment of the present disclosure, light L1 incident from at least one first light source 2100 to at least one first incident portion 2210 and traveling in a frontward direction may be reflected by the first reflecting portion 2231 and the second reflecting portion 2232 of the first light-transfer portion 2230 so as to travel backwards. The light L1 may then be reflected by the third reflecting portion 2233 and the fourth reflecting portion 2234 so as to travel in a frontward direction and then be emitted in a frontward direction through the first light-emitting portion 2220. Subsequently, the light L1 emitted from the first light-emitting portion 2220 may proceed to the optical portion 2300. Thus, the low beam pattern LP shown in FIG. 6 as described above may be formed.

In addition, light L2 emitted in a frontward direction from the at least one second light source 3100 may be guided through the at least one guiding member 3210 to travel to the optical portion 2300 to form the high beam pattern HP shown in FIG. 15 as described above.

In another embodiment of the present disclosure, when the low beam pattern LP is formed, the first lamp module 2000 may be turned on, and the second lamp module 3000 may be turned off. When the high beam pattern HP is formed, the first lamp module 2000 and the second lamp module 3000 may be turned on concurrently, so that the high beam pattern HP and the low beam pattern LP may be formed together.

In this regard, the second lamp module 3000 may not be used when the low beam pattern LP is formed. Thus, a third beam pattern may be formed by the second lamp module 3000 when the low beam pattern LP is formed, so that the second lamp module 3000 may be used even when the low beam pattern LP is formed, thereby improving usability thereof.

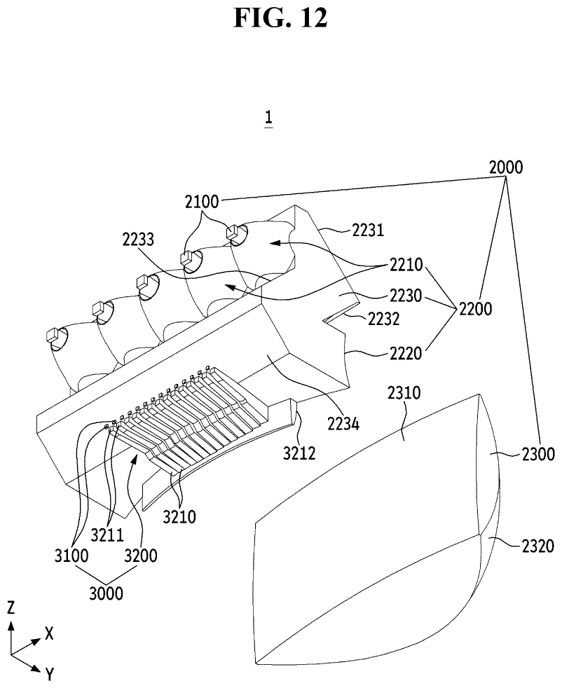

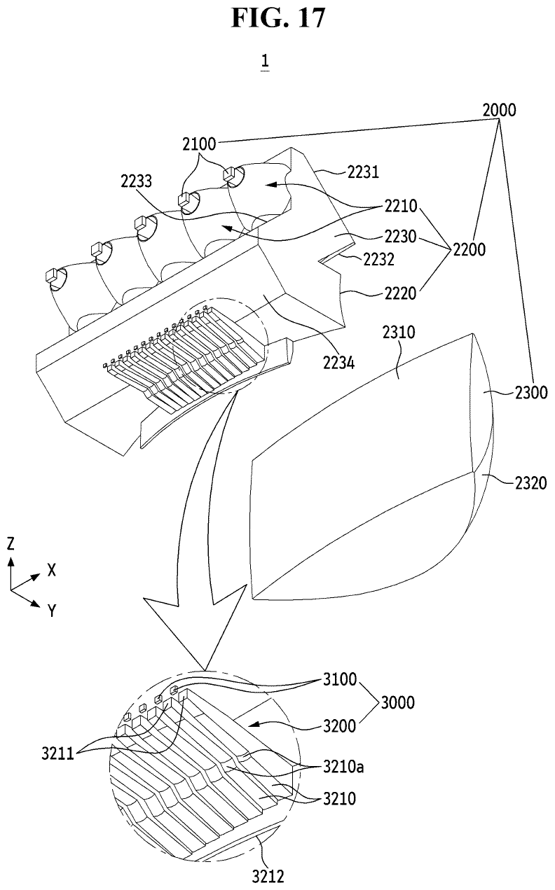

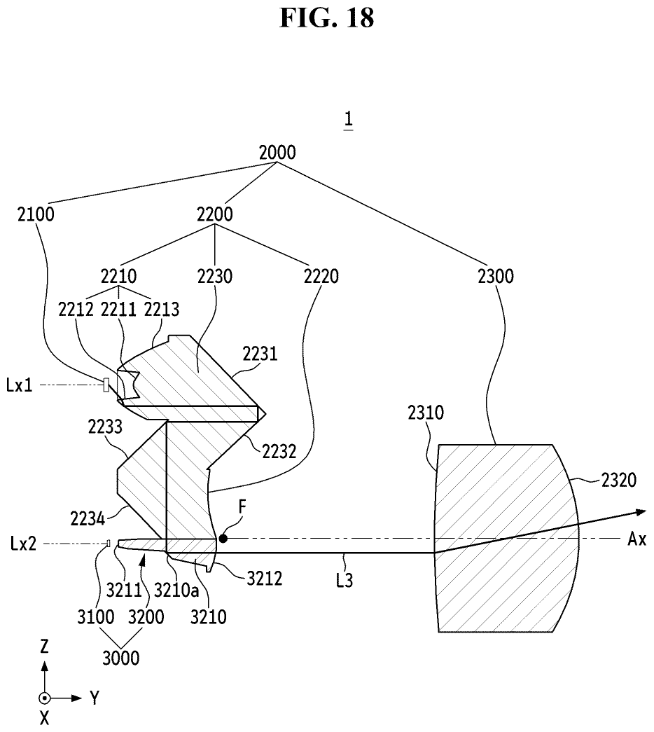

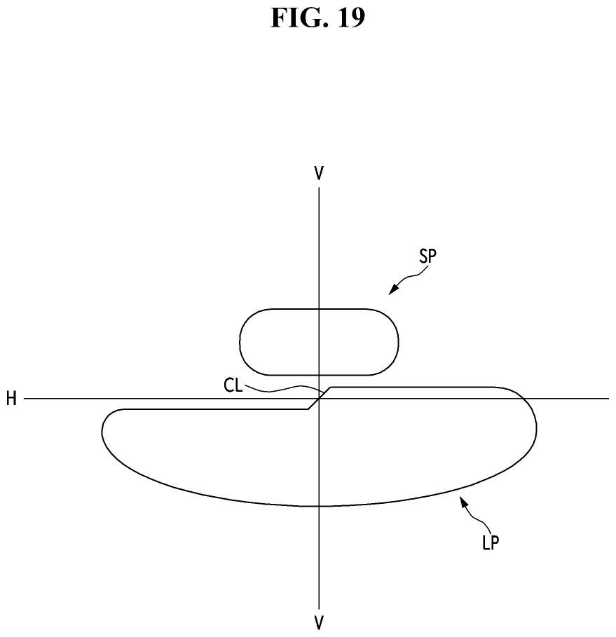

FIG. 17 is a perspective view illustrating a lamp for a vehicle according to still another embodiment of the present disclosure, FIG. 18 is a cross-sectional view illustrating a lamp for a vehicle according to still another embodiment of the present disclosure, FIG. 19 is a schematic diagram illustrating a beam pattern formed by the lamp for a vehicle according to still another embodiment of the present disclosure, and FIG. 17 is an example in which a partial area of FIG. 12 described above is illustrated in an enlarged manner.

Referring to FIGS. 17 to 19, in the lamp 1 for a vehicle according to still another embodiment of the present disclosure, a light path adjustment portion 3210a may be formed on at least a portion of a lower surface of at least one guiding member 3210 of the second lamp module 3000. The light path adjustment portion 3210a may include a front end and a rear end. A spacing between the front end of the light path adjustment portion 3210a and the central axis Ax of the optical portion 2300 may be greater than a spacing between the rear end thereof and the central axis Ax of the optical portion 2300. The light path adjustment portion 3210a may reflect a portion of light L3 incident thereto from the first light guide 2200 so as to cause the light L3 to travel in a frontward direction. Accordingly, at least a portion of the light may proceed above the cut-off line CL of the low beam pattern LP, thereby forming a signal beam pattern SP that enables easier identification of a road sign or the like disposed above a driver's viewpoint. The signal beam pattern SP may be formed to have brightness controlled to prevent glare from occurring toward the driver of the front vehicle.

As described above, in the still another embodiment of the present disclosure, even when the low beam pattern LP is formed, the signal beam pattern SP as the third beam pattern may be formed by the second lamp module 3000, such that the utilization of the second lamp module 3000 may be improved.

In addition, the signal beam pattern SP being formed by the second lamp module 3000 in still another embodiment of the present disclosure is merely an example for helping understanding of the present disclosure. The present disclosure is not limited thereto, and the type of the third beam pattern may vary depending on the size, inclination angle, curvature, and the like of the light path adjustment portion 3210a.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. A lamp for a vehicle including at least one lamp module that forms a beam pattern, wherein the at least one lamp module comprises:
at least one light source for emitting light in a forward direction;
a light guide including at least one light-receiving portion and a light-emitting portion that are vertically spaced apart, wherein the light guide guides the light incident on the at least one light-receiving portion from the at least one light source to be emitted through the light-emitting portion in the forward direction; and
an optical portion that allows the light emitted in the forward direction from the light guide to be transmitted therethrough and form the beam pattern.

2. The lamp for the vehicle of claim 1, wherein the light guide allows the light that is incident onto the at least one light-receiving portion and proceeds in the forward direction to travel in a rearward direction at least one time and subsequently to be emitted in the forward direction through the light-emitting portion.

3. The lamp for the vehicle of claim 1, wherein the light guide further includes a light-transfer portion that transmits the light between the at least one light-receiving portion and the light-emitting portion, and
wherein the light-transfer portion includes a plurality of reflective portions that reflect the light incident on the at least one light-receiving portion to allow the reflected light to proceed to the light-emitting portion.

4. The lamp for the vehicle of claim 3, wherein at least one of the plurality of reflective portions includes a plurality of reflective areas.

5. The lamp for the vehicle of claim 4, wherein at least one of a formation angle or a curvature of one of the plurality of reflective areas is different from at least another of the plurality of reflective areas.

6. The lamp for the vehicle of claim 3, wherein a reflective portion among the plurality of reflective portions, which is disposed immediately upstream of the light-emitting portion along a light transfer path within the light-transfer portion, consists essentially of a single reflective area.

7. The lamp for the vehicle of claim 3, wherein the plurality of reflective portions includes:
a first reflective portion disposed in front of the at least one light-receiving portion;
a second reflective portion arranged vertically with the first reflective portion and disposed more proximate to the light-emitting portion than the first reflective portion;
a third reflective portion disposed longitudinally behind the second reflective portion; and
a fourth reflective portion arranged vertically with the third reflective portion and disposed more proximate to the light-emitting portion than the third reflective portion.

8. The lamp for the vehicle of claim 7, wherein the first reflective portion reflects the light so as to cause it to travel vertically and toward the second reflective portion,
wherein the second reflective portion reflects the light reflected from the first reflective portion so as to cause it to travel in a rearward direction and toward the third reflective portion,
wherein the third reflective portion reflects the light reflected from the second reflective portion so as to cause it to travel vertically and toward the fourth reflective portion, and
wherein the fourth reflective portion reflects the light reflected from the third reflective portion so as to cause it to travel in the forward direction and toward the light-emitting portion.

9. The lamp for the vehicle of claim 7, wherein at least one of the first to third reflective portions includes a plurality of reflective areas.

10. The lamp for a vehicle of claim 7, wherein the fourth reflective portion consists essentially of a single reflective area.

11. The lamp for the vehicle of claim 1, wherein one end of both vertically opposing ends of the light-emitting portion that is closer to an optical axis of the optical portion is disposed at or near a rear focus of the optical portion.

12. The lamp for the vehicle of claim 1, wherein the light-emitting portion has a concave shape in which the light-emitting portion becomes closer to the optical portion as the light-emitting portion extends from a center thereof toward each of both opposing sides thereof.

13. The optical portion of claim 1, wherein the optical portion includes:
a light-receiving surface on which the light emitted from the light guide is incident, and
a light-emitting surface through which the light incident on the light-receiving surface is emitted,
wherein the light-receiving surface is formed to be convex in a rearward direction,
wherein the light-emitting surface is formed to be convex in the forward direction, and
wherein a curvature of the light-emitting surface is formed to be greater than a curvature of the light-receiving surface.

14. A lamp for a vehicle comprising a first lamp module and a second lamp module that form a first beam pattern and a second beam pattern, respectively, wherein the first lamp module comprises:
at least one first light source for emitting light in a forward direction;
a first light guide including at least one first light-receiving portion and a first light-emitting portion that are vertically spaced apart from each other, wherein the first light guide guides the light incident on the at least one first light-receiving portion from the at least one first light source to be emitted through the first light-emitting portion in the forward direction; and
an optical portion that allows the light emitted in the forward direction from the first light guide to be transmitted therethrough and form the first beam pattern,
wherein the second lamp module is vertically arranged with the first lamp module with an optical axis of the optical portion being disposed therebetween in a vertical direction, and
wherein the second lamp module comprises:
at least one second light source for emitting light in the forward direction; and
a second light guide that guides the light incident thereon from the at least one second light source to travel to the optical portion and form the second beam pattern.

15. The lamp for the vehicle of claim 14, wherein the first light guide includes a first light-transfer portion that transmits the light incident to the first light-receiving portion to the first light-emitting portion, and
wherein the first light-transfer portion includes a plurality of reflective portions arranged along a traveling path of the light incident to the first light-receiving portion.

16. The lamp for the vehicle of claim 15, wherein the first light-transfer portion allows the light that is incident to the first light-receiving portion and proceeds in the forward direction to be reflected from the plurality of reflective portions so as to travel in a rearward direction at least once and subsequently to be emitted in the forward direction through the first light-emitting portion.

17. The lamp for the vehicle of claim 14, wherein a vertical spacing between the first light-emitting portion and the optical axis of the optical portion is smaller than a vertical spacing between the first light-receiving portion and the optical axis of the optical portion.

18. The lamp for the vehicle of claim 14, wherein a vertical spacing between the at least one first light source and the optical axis of the light source portion is greater than a vertical spacing between the at least one second light source and the optical axis of the light source portion.

19. The lamp for the vehicle of claim 14, wherein the second light guide includes at least one guiding member, each having a front end and a rear end, wherein the guiding member guides light incident on the rear end from the at least one second light source to be emitted through the front end and subsequently to proceed to the optical portion, and
wherein a vertical height of the front end of each of the at least one guiding member is smaller than a vertical height of the first light-emitting portion.

20. The lamp for the vehicle of claim 19, wherein the at least one guiding member includes a light path adjustment portion, and
wherein, with the second lamp module being turned off, the light path adjustment portion reflects a portion of light transmitted from the first light guide so as to cause it to travel in the forward direction, thereby allowing a third beam pattern to be formed.
